(19) United States
(12) Patent Application Publication
(10) Pub. No.: US 2017/0223161 A1
(43) Pub. Date: Aug. 3, 2017

(54) STAND FOR MOBILE PHONE

(71) Applicant: Cutter Technologies Pte Ltd, Singapore (SG)

(72) Inventor: Choon Meng LAU, Singapore (SG)

(21) Appl. No.: 14/902,846

(22) PCT Filed: Aug. 26, 2015
(86) PCT No.: PCT/SG15/50280

§ 371 Date: Jan. 4, 2016

(51) Int. Cl. H04M 1/04; F16M 11/20; A45C 11/00; F16M 11/38

(52) U.S. Cl. CPC H04M 1/04; F16M 11/38; F16M 11/2021; A45C 11/00; A45C 2011/002; A45C 2200/15

(57) ABSTRACT

A stand for a mobile phone, the stand comprising: a plate configured to be removably attached to a back of a mobile phone or phone casing; a support panel having a first end and a second end, the first end configured to pivotably engage a lower edge of the plate about a first axis and the second end configured to rest on a surface on which the stand and the mobile phone are placed when the stand is attached to the mobile phone; an adjustment leg having a pivoting end and an engagement end, the pivoting end configured to pivotably engage an upper edge of the plate about a second axis and the engagement end configured to releasably and selectably engage the support panel at one of a plurality of engagement locations provided along a length of the support panel.

### FIELD OF THE INVENTION

This invention relates to a stand for a mobile phone to keep the mobile phone propped up at an angle of inclination on a surface.

### BACKGROUND OF THE INVENTION

It is often desirable to keep a mobile phone propped up at an angle of inclination on a surface so that a user is freed from manually holding the mobile phone during use. Existing stand designs have their own drawbacks, and there is a need to provide a stand that is easy to set up according to the user's preferred angle of inclination of the mobile phone, that keeps the mobile phone stable when a screen or button of the mobile phone is frequently touched, and that can be compactly stored without being misplaced.

### SUMMARY OF INVENTION

According to an exemplary aspect, there is provided a stand for a mobile phone, the stand comprising: a plate configured to be removably attached to a back of a mobile phone or phone casing; a support panel having a first end and a second end, the first end configured to pivotably engage a lower edge of the plate about a first axis and the second end configured to rest on a surface on which the stand and the mobile phone are placed when the stand is attached to the mobile phone; an adjustment leg having a pivoting end and an engagement end, the pivoting end configured to pivotably engage an upper edge of the plate about a second axis and the engagement end configured to releasably and selectably engage the support panel at one of a plurality of engagement locations provided along a length of the support panel.

The plate, the support panel and the adjustment leg may be integrally formed with one another such that the stand is of a one-piece construction.

The first end may pivotably engage the lower edge of the plate via a living hinge and the pivoting end may pivotably engage the upper edge of the plate via a living hinge.

The plurality of engagement locations may comprise a plurality of slots provided on the support panel.

The engagement end comprises a locking tab may be configured to releasably engage each of the plurality of slots.

The engagement end may comprise a flap on which the locking tab is provided, the flap configured to be pivotable via a living hinge at the engagement end about a third axis that is parallel to the first axis.

The plate, the adjustment leg, and the support panel may be configured to lie parallel to the back of the mobile phone when the stand is attached to the mobile phone and in a stored position.

At least one securing tab may be provided on the adjustment leg to engage a corresponding at least one securing slot provided on the support panel to keep the stand in the stored position.

The at least one securing tab and the at least one securing slot may be provided orthogonally to the first axis.

### BRIEF DESCRIPTION OF FIGURES

In order that the invention may be fully understood and readily put into practical effect there shall now be described by way of non-limitative example only exemplary embodiments of the present invention, the description being with reference to the accompanying illustrative drawings.

FIG. 1 is perspective view of an exemplary embodiment of a stand for a mobile phone in an active position according to the present invention.

FIG. 2 is a side view of the stand of FIG. 1.

FIG. 3 is a side view of the stand when released from the active position.

FIG. 4 is a side view of the stand when in a partially stored position.

FIG. 5 is a side view of the stand in a stored position.

FIG. 6 is a plan view of the stand in a stored position.

### DETAILED DESCRIPTION

Exemplary embodiments of the stand 10 will be described with reference to FIGS. 1 to 6 in which the same reference numerals are used to refer to equivalent parts.

The stand 10 comprises a plate 20 configured to be removably attached to an attachment area 230 at a back 200 of a mobile phone 100. The attachment area 230 is preferably at a central portion of the back 200 of the mobile phone 100. When the stand 10 is attached to the mobile phone, in an active position of the stand 10, a bottom edge 120 of the mobile phone 100 rests on a surface 90 on which the stand 10 and the mobile phone 100 are placed.

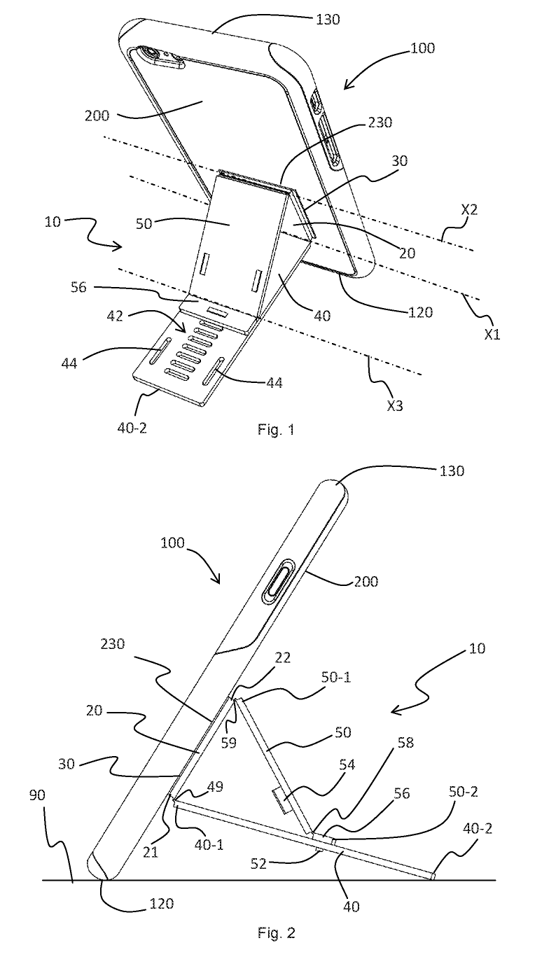

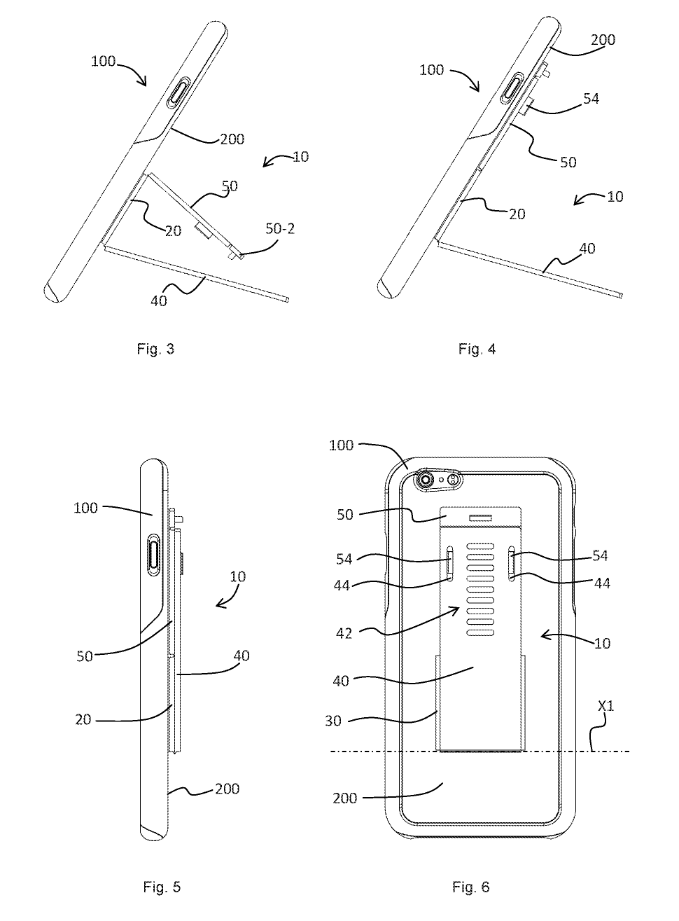

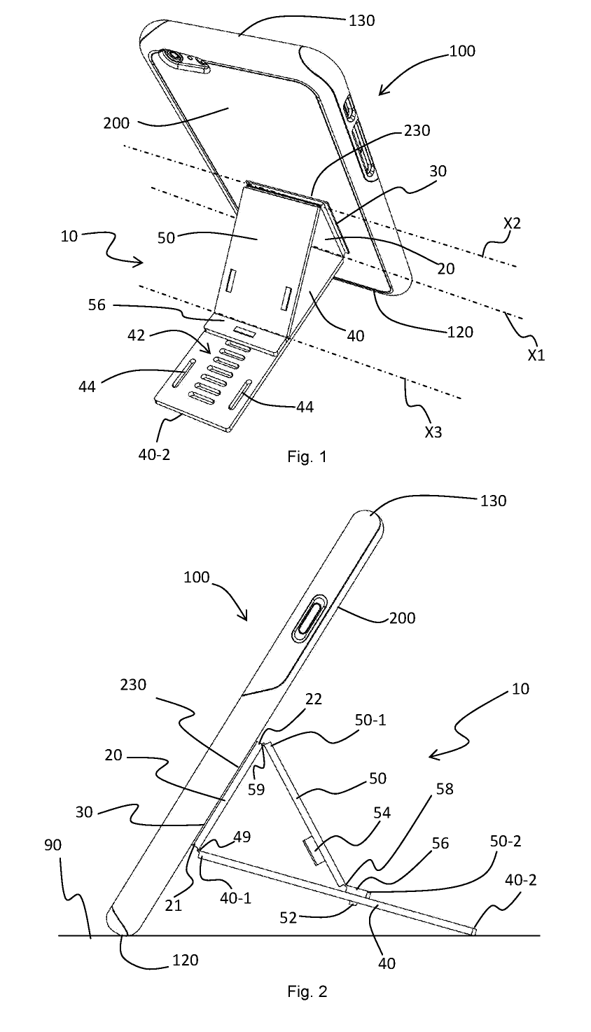

The stand 10 further comprises a support panel 40 having a first end 40-1 that is configured to pivotably engage a lower edge 21 of the plate 20 about a first axis X1. The first axis X1 is preferably parallel to the surface 90 on which the stand 10 is placed when the stand 10 is attached to the mobile phone 100. In the exemplary embodiment, as can be seen in FIG. 2, the first end 40-1 of the support panel 40 is connected to the lower edge 22 of the plate 20 via a living hinge 49 that pivots about the first axis X1, such that the support panel 40 is preferably integrally formed with the plate 20.

A second end 40-2 of the support panel 40 is configured to rest on the surface 90 on which the stand 10 is placed. Although the figures show the support panel 40 as having a generally rectangular shape, the support panel 40 may comprise any other desired or appropriate shape, for example, the second end 40-2 of the support panel 40 may be configured to be wider than the first end 40-1 of the support panel 40 in order to give greater stability to the stand 10 when in use in an active position of the stand 10.

The stand 10 further comprises an adjustment leg 50 having a pivoting end 50-1 that is configured to pivotably engage an upper edge 22 of the plate 20 about a second axis X2. The second axis X2 is located above, parallel to and distanced apart from the first axis X1 when the stand 10 is attached to the mobile phone 100 and the mobile phone 100 is in an upright position. In the exemplary embodiment, as can be seen in FIG. 2, the pivoting end 50-1 of the adjustment leg 50 is connected to the upper edge 21 of the plate 20 via a living hinge 59 that pivots about the second axis X2, such that the adjustment leg 50 is preferably integrally formed with the plate 20.

An engagement end 50-2 of the adjustment leg 50 is configured to releasably and selectably engage the support panel 40 at one of a plurality of engagement locations 42 provided along a length of the support panel 40. The plurality of engagement locations 42 are configured such that when the stand 10 is attached to the mobile phone 100, engagement of the engagement end 50-2 with one of the plurality of engagement locations nearer to the first end 40-1 of the support panel 40 raises the top edge 130 of the mobile phone 100 relative to the surface 90 on which the mobile phone 100 and the stand 10 rest, while engagement of the engagement end 50-2 at one of the plurality of engagement locations nearer to the free end 40-2 of the support panel 40 lowers the top edge 130 of the mobile phone 100 relative to the surface 90.

Thus, by selecting one of the plurality of engagement locations 42 provided on the support panel 40 with which the engagement end 50-2 of the adjustment leg 50 is engaged when the stand 10 is in an active position, the user accordingly selects an angle of inclination of the mobile phone 100 relative to the surface 90 on which rest the bottom edge 120 of the mobile phone 100 and the free end 40-2 of the support panel 40.

In a preferred embodiment as shown in FIGS. 1 and 2, the plurality of engagement locations 42 comprise a plurality of slots 42 provided on the support panel 40. The plurality of slots 42 are spaced apart from each other and preferably parallel to the first axis X1. In the preferred embodiment, the plurality of slots 42 comprise through holes in the support panel 40, although in alternative embodiments the plurality of slots 42 may comprise blind holes in the support panel 40. The engagement end 50-2 of the adjustment leg 50 comprises a locking tab 52 configured to releasably engage each of the plurality of slots 42. When the locking tab 52 is in engagement with one of the plurality of slots 42, the stand 10 is in the active position that causes the mobile phone 100 to be propped up at an angle of inclination relative to the surface 90 when the second end 40-2 of the support panel 40 and the bottom edge 120 of the mobile phone 100 are allowed to rest on the surface 90.

The engagement end 50-2 preferably comprises a flap 56 on which the locking tab 52 is provided, in order to allow easy engagement and release of the locking tab 52 with any one of the plurality of slots 42. The flap 56 is pivotable about a third axis X3 that is parallel to the first and second axes X1, X2. Preferably, the flap 56 is configured to be pivotable via a living hinge 58 provided at the engagement end 50-2, such that the flap 56 is integrally formed with the adjustment leg 50.

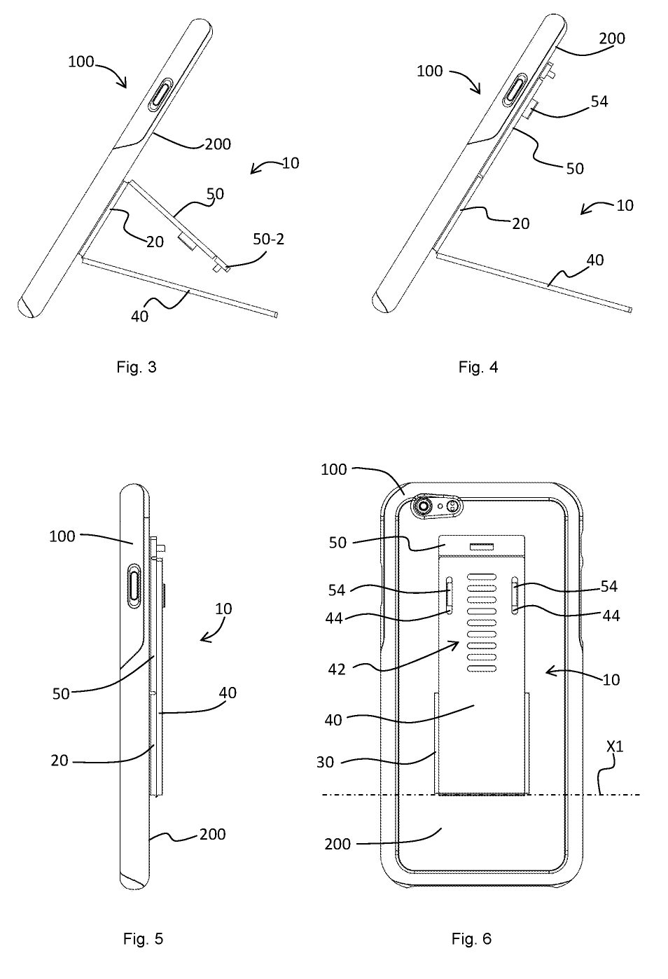

To configure the stand 10 in a stored position as shown in FIGS. 5 and 6, the engagement end 50-2 is released from engagement with the support panel 40 as shown in FIG. 3, and the adjustment leg 50 is brought to lie flat against the back 200 of the mobile phone 100 to be collinear with the plate 20, as shown in FIG. 4. When the support panel 40 is brought to lie flat against the plate 20 and the adjusting leg 40, as shown in FIG. 5, the stand 10 is in the stored position that is parallel to the back 200 of the mobile phone 100, thereby minimizing space taken up by the stand 10.

To keep the stand 10 in the stored position, a pair of securing tabs 54 are provided on the adjustment leg 50 while a pair of securing slots 44 are provided on the support panel 40. The securing tabs 54 are each configured to fit into a corresponding each of the securing slots 44 to secure the adjustment leg 50 to the support panel 40 when the stand 10 is in the stored position, as shown in FIG. 6. The securing slots 44 are preferably provided one on each side of the plurality of slots 42 in the support panel 40. The securing tabs 54 and securing slots 44 are preferably provided orthogonally to the first axis X1, so as to allow easy engagement and disengagement of the securing tabs 54 with the securing slots 44.

In order to avoid misplacing the stand 10, the stand 10 is configured to remain attached to the mobile phone 100 in both the stored position and the active position. To keep the stand 10 attached to the mobile phone 100, a reusable gel sticker 30 may be used. Alternatively, any other removable attaching means such as double sided tape or glue may be used.

By configuring the stand 10 to be integrally formed so that the stand 10 is of a one-piece construction, while providing living hinges 49, 59 and 58 to allow the various components 20, 40, 50 of the stand 10 to be configurable between the stored position or an active position, a low cost, compact and sturdy stand 10 is thus provided that allows the mobile phone 100 to be propped up at a number of different available active positions according to the user's preference. Appreciably, the number of active positions available for selection corresponds to the number of engagement locations 42 provided on the support panel 40.

Whilst there has been described in the foregoing description an exemplary embodiment of the present invention, it will be understood by those skilled in the technology concerned that many variations in details of design, construction and/or operation may be made without departing from the present invention. For example, while the engagement end of the adjustment leg has been described as preferably comprising a flap on which the locking tab is provided, in alternative embodiments, the flap may be omitted while still providing the locking tab at a free edge of the engagement end of the adjustment leg. While a pair of securing tabs and a pair of securing slots have been described above as being provided to keep the stand in a stored position, in alternative embodiments, other numbers of securing slots and securing tabs may be provided. While it has been described above that the stand is attached to the back of the mobile phone, it will be understood that the stand may alternatively be attached to the back of a phone casing in which the mobile phone is usually housed. While the plate, the support panel and the adjustment leg have been depicted in the figures as being rectangular in shape, the plate, the support panel and the adjustment leg may have any other conceivable shape that still allows them to be in the stored and active positions as described above.

1. A stand for a mobile phone, the stand comprising:
a plate configured to be removably attached to a back of a mobile phone or phone casing;
a support panel having a first end and a second end, the first end configured to pivotably engage a lower edge of the plate about a first axis and the second end configured to rest on a surface on which the stand and the mobile phone are to be placed when the stand is attached to the mobile phone;
an adjustment leg having a pivoting end and an engagement end, the pivoting end configured to pivotably engage an upper edge of the plate about a second axis and the engagement end configured to releasably and selectably engage the support panel at one of a plurality of engagement locations provided along a length of the support panel.

2. The stand of claim 1, wherein the plate, the support panel and the adjustment leg are integrally formed with one another such that the stand is of a one-piece construction.

3. The stand of claim 2, wherein the first end pivotably engages the lower edge of the plate via a living hinge and wherein the pivoting end pivotably engages the upper edge of the plate via a living hinge.

4. The stand of any preceding claim 1, wherein the plurality of engagement locations comprise a plurality of slots provided on the support panel.

5. The stand of claim 4, wherein the engagement end comprises a locking tab configured to releasably engage each of the plurality of slots.

6. The stand of claim 5, wherein the engagement end comprises a flap on which the locking tab is provided, the flap configured to be pivotable via a living hinge at the engagement end about a third axis that is parallel to the first axis.

7. The stand of claim 1, wherein the plate, the adjustment leg, and the support panel are configured to lie parallel to the back of the mobile phone when the stand is attached to the mobile phone and in a stored position.

8. The stand of claim 7, wherein at least one securing tab is provided on the adjustment leg to engage a corresponding at least one securing slot provided on the support panel to keep the stand in the stored position.

9. The stand of claim 8, wherein the at least one securing tab and the at least one securing slot are provided orthogonally to the first axis.
